(19) United States
(12) Patent Application Publication
(10) Pub. No.: US 2024/0278163 A1
(43) Pub. Date: Aug. 22, 2024

(54) ROUND FILTER ELEMENT AND FILTER DEVICE

(71) Applicant: MANN+HUMMEL GmbH, Ludwigsburg (DE)

(72) Inventors: Daniel SCHMID, Sachsenheim (DE); Philipp HETTKAMP, Steinheim (DE); Eva HALLBAUER, Himmelkron (DE); Volkmar CHOWANIETZ, Bayreuth (DE); Mario RIEGER, Ludwigsburg (DE)

(21) Appl. No.: 18/648,705

(22) Filed: Apr. 29, 2024

Related U.S. Application Data
(63) Continuation of application No. PCT/EP2022/077887, filed on Oct. 7, 2022.

(30) Foreign Application Priority Data
Nov. 4, 2021 (DE) 102021128717.0

(51) Int. Cl. B01D 46/64; B01D 46/00; B01D 46/52; B01D 53/02; H01M 8/0662

(52) U.S. Cl. CPC B01D 46/64; B01D 46/0036; B01D 46/521; B01D 53/02; H01M 8/0687; B01D 2253/102; B01D 2257/302; B01D 2257/404; B01D 2257/406; B01D 2271/027; B01D 2275/201

(57) ABSTRACT

A round filter element for filtering gaseous fluid has a particle filter medium body and a separate noxious gas filter medium body arranged concentrically in relation to the particle filter medium body. The particle filter medium body and the noxious gas filter medium body surround an inwardly positioned flow chamber. A first common end plate flow-tightly covers a respective first end face of the particle filter medium body and of the noxious gas filter medium body. A second common end plate flow-tightly covers a respective second end face of the particle filter medium body and of the noxious gas filter medium body. The particle filter medium body is a filter bellows and the noxious gas filter medium body is a filter bellows. A filter device having a filter housing is provided with such a filter element.

### CROSS-REFERENCE TO RELATED APPLICATIONS

This application is a continuation application of international application No. PCT/EP2022/077887 having an international filing date of Oct. 7, 2022, and designating the United States, the international application claiming a priority date of Nov. 4, 2021, based on prior filed German patent application No. 10 2021 128 717.0, the entire contents of the aforesaid international application and the aforesaid German patent application being incorporated herein by reference.

### BACKGROUND

The invention relates to a round filter element for filtration of a gaseous fluid with a particle filter medium body configured as a hollow body for particle filtration and a separate noxious gas filter medium body embodied as a hollow body for noxious gas filtration.

Furthermore, the invention concerns a filter device with a filter housing and such a round filter element, for example, for fuel cell applications.

DE 10 2018 215 603 A1 describes a modular filter element for fuel cell applications. The filter element comprises two hollow-cylindrical filter modules in a housing, wherein the filter modules each are comprised of a folded filter material and are arranged concentrically relative to each other. The filter element is flowed through radially from the exterior to the interior, wherein the purified gas is discharged axially. The filter body of the first filter module serves for particle filtration, the filter body of the second filter module comprises an active carbon medium in order to filter out undesirable gases. The two filter bodies are detachably connected to each other.

US 2003/0096152 A1 also discloses a round filter element that is constructed of two concentrically arranged hollow-cylindrical filter bodies which are flowed through radially from the exterior to the interior. The round filter element can be used in a filter device for a fuel cell. The outwardly positioned filter body forms a particle filter, the inwardly positioned filter body is embodied as a carbon filter in the form of an extruded porous block.

### SUMMARY

It is an object of the invention to provide a round filter element for filtration of a gaseous fluid, comprising a particle filter medium body and a noxious gas filter medium body, which can be produced in a simple manner and comprises a high filtration efficiency.

This object is solved according to the invention by a round filter element for filtration of a gaseous fluid with a particle filter medium body configured as a hollow body for particle filtration of the gaseous fluid and with a separate noxious gas filter medium body configured as a hollow body for noxious gas filtration, which is arranged concentrically to the particle filter medium body, wherein the two filter medium bodies surround an inwardly positioned flow chamber, wherein both filter medium bodies are configured as filter bellows, wherein an end face of the particle filter medium body as well as of the noxious gas filter medium body is covered flow-tightly by a first common end plate, and wherein also the oppositely positioned end face of the particle filter medium body as well as of the noxious gas filter medium body is covered flow-tightly by a second common end plate.

The round filter element according to the invention is used for the filtration of a gaseous fluid, for example, for the filtration of air. A round filter element is to be understood as a filter element with annular closed filter medium. In other words, the filter medium surrounds a radially inwardly positioned hollow chamber. The round filter element can be part of a filter device which comprises an openable filter housing and a round filter element received exchangeably in the filter housing. The filter device can be used in or at a fuel cell, for example, in the supply region of the ambient air to be supplied to a fuel cell in order to subject the ambient air to a filtration. Such filter devices may also be referred to as cathode air filters.

The particle filter medium body and the noxious gas filter medium body which are arranged concentrically relative to each other surround an inwardly positioned flow chamber. Both filter medium bodies can have a circular or an elongate cross section shape, for example, oval or with semicircular narrow sides and straight or convexly or concavely designed longitudinal sides. In axial direction—relating to the longitudinal axis of the round filter element—the round filter element comprises either a constant cross-sectional surface area—is thus hollow-cylindrical—or comprises a changing cross-sectional surface area, for example, a continuously changing cross-sectional surface area in case of a conical element. In addition, the two filter medium bodies can have different lengths in axial direction.

Flow through the round filter element is realized either radially from the interior to the exterior or, in reverse, radially from the exterior to the interior, wherein the term “radial” relates to the longitudinal axis of the round filter element. In case of a radial flow from the interior to the exterior, the non-purified raw fluid is guided first into the inwardly positioned flow chamber, from where the radial flow through the filter medium bodies is realized from the interior to the exterior. In case of radial flow from the exterior to the interior, the purified fluid is collected in the inwardly positioned flow chamber and is axially discharged from it.

The particle filter medium body is located at the inflow side of the raw fluid, the noxious gas filter medium body lies downstream of the particle filter medium body. Accordingly, the inflow side of the particle filter medium body is the raw side and the outflow side of the noxious gas filter medium body is the clean side.

The noxious gas filter medium body contains, for example, active carbon and is capable of separating noxious gases from the gaseous fluid, for example, sulfur dioxide, nitrogen oxides, or ammonia. The noxious gas filter medium body can advantageously comprise a folded active carbon-containing filter medium whose end face edges are glued in order to avoid a discharge of active carbon particles out of the filter medium.

Both filter medium bodies are embodied as a filter bellows of zigzag-shaped folded filter medium. Such filter bellows enable a high filtration efficiency.

Both filter medium bodies are flow-tightly covered at both axially oppositely positioned end faces by a common end plate, respectively. The common end plate flow-tightly covers the end faces of both filter medium bodies. The common end plate simplifies the manufacture of the round filter element. It is sufficient to produce the end plate at each end face for both filter medium bodies in a single working step, for example, as a cast component of a, for example, soft-elastic material. As end plate material, for example, polyurethane or plastic material is conceivable.

The round filter element is provided with a gas-permeable support element arranged at the wall side of a filter medium body. In case of a filter medium body of folded filter medium, the inflow-side or the outflow-side fold tips form a wall side, respectively. The support element has a supporting and stabilizing function in that the immediately neighboring filter medium body can be supported radially at the support element. In this way, the second filter medium body, which is not immediately neighboring the support element, is also indirectly-via the first filter medium body—radially supported. The gas-permeable support element may be comprised, for example, of plastic material and comprises a plurality of openings through which the gaseous fluid can flow. The gas-permeable support element may be, for example, a support grid of plastic material. However, a metallic support element, for example, a perforated sheet metal, is conceivable also.

Advantageously, the support element projects into the material of at least one end plate and is fixedly connected to the end plate. This embodiment has the advantage that a fixed connection between the filter medium bodies and the support element is provided by means of the end plates. The relative position of the support element to the immediately adjoining filter medium body is fixed in this manner. Both filter medium bodies and the support element, together with the end plates, form a structural unit.

According to an advantageous embodiment, the support element projects into the material of both end plates and is fixedly connected to the two end plates. This is realized, for example, in that the end plates are embodied as cast components and the projecting section of the support element is enclosed in the end plate material. This embodiment has the advantage that the fixed connection with the support element is achieved already upon manufacturing the end plates.

In an advantageous embodiment, a circumferential seal carrier is formed as one piece together with the support element. In an alternative embodiment without support element, the seal carrier is embodied as a circumferentially extending frame. The seal carrier can comprise a receiving groove, for example, open in axial direction, for a seal element. The seal carrier can be arranged near an end face of the outer filter medium body and can be embedded in the end plate material.

According to an advantageous embodiment, laterally projecting support legs are provided at one end plate. The support legs are for example, embodied as one piece together with the end plate; they can be laterally integrally formed at the end plate. The support legs enable a support action, for example, transverse or radially to the longitudinal axis, as needed, also in axial direction. In case of a conical round filter element which, across its axial length, has a changing diameter, the support legs are located, for example, at the narrower side of the round filter element. For example, four support legs, distributed about the circumference, are provided at the end plate.

According to yet another advantageous embodiment, a gas-permeable media layer is arranged at least at one wall side of a filter medium body. The media layer, which is usually of a thin configuration and comprises a smaller thickness than the filter medium body, acts to reduce friction so that correspondingly a reduced friction is present compared to an immediate contact between support element and one of the filter medium bodies or between the two filter medium bodies. The reduced friction reduces forces in axial direction and in circumferential direction which otherwise can act on the filter medium body in case of an immediate contact. A further advantage is that particles of the filter medium body at whose lateral surface the gas-permeable media layer is located are retained by this media layer. For example, a discharge of active carbon particles from a filter medium body with active carbon-containing filter medium can be prevented. The gas-permeable media layer is, for example, a nonwoven layer. As an alternative, woven media layers, for example, embodied as a single layer, are, for example, conceivable which comprise a high permeability for the gaseous fluid to be filtered in order to keep the flow resistance low.

The media layer is located, for example, at a wall side of the noxious gas filter medium body. An arrangement of the media layer is conceivable at the outflow side of the noxious gas filter medium body at which optionally also the support element is located, wherein the media layer is positioned between support element and outflow side of the noxious gas filter medium body. The media layer can be molded onto the support element and positionally fixed in this way. In addition or as an alternative, it is also possible to position a gas-permeable media layer, for example, nonwoven layer, between the two filter medium bodies, wherein in this case particles from the particle filter medium body, positioned upstream in flow direction, are retained and a supply of particles to the noxious gas filter medium body is prevented. In addition, the friction between the filter medium bodies is reduced. Advantageously, the separating media layer is configured as a nonwoven layer.

In an advantageous embodiment, at least a first gas-permeable media layer is provided between the two filter medium bodies and at least a second gas-permeable media layer is provided at the outflow side of the noxious gas filter medium body. The second media layer comprises in this context, for example, a higher degree of separation for particles to be filtered than the first media layer.

The media layer extends for example, across the entire wall side of the adjoining filter medium body. The media layer, according to a further advantageous embodiment, can also be connected to one or to both end plates. Alternatively, for example, in case that the end plates are foamed onto the filter medium bodies, it can be expedient that the media layer is shorter than the filter medium body so that it is ensured that the region about the end faces is completely surrounded by the end plate material. For example, the first gas-permeable media layer can extend across less than the entire height of the two filter medium bodies, for example, across two thirds of the height. The intermediate layer should extend however across at least half of the height of the filter medium bodies in order to ensure a reliable separation of the folds.

According to a further advantageous embodiment, at least one of the filter medium bodies, for example, the noxious gas filter medium body, comprises at least two partial bodies which are connected to each other at an axial end face, respectively. For example, in case of long filter elements, it can be advantageous with regard to manufacturing technology to manufacture, instead of a one-piece filter medium body, several shorter partial bodies and to arrange them axially on top of each other and connect them to a longer filter medium body. The connection can be realized, for example, by an adhesive. The partial bodies can be embodied advantageously as folded filter bellows.

In a further embodiment in which the multi-part filter medium body is arranged so as to be positioned outwardly, a seal carrier, which projects radially outwardly past the partial bodies and supports a seal element, can be provided between the two partial bodies. The seal carrier can be a plastic part on which the seal element is integrally formed, for example, injection molded. Alternatively, the seal element can be a separate element and, for example, introduced into a groove of the seal carrier. The seal arrangement serves for sealing in relation to the housing, i.e., the seal element is resting against a seal surface of the filter housing in the installed state. In case a support element, for example, a support grid, is present. the seal carrier can be embodied as one piece together with the support element, for example, as a radially expanded collar.

The invention relates furthermore to a filter device with a filter housing and an afore described round filter element received in the filter housing. The filter device can be used in or at a fuel cell, for example, for filtration of cathode air. The round filter element is exchangeably arranged in the filter housing.

### BRIEF DESCRIPTION OF THE DRAWINGS

Further advantages and expedient embodiments can be taken from the further claims, the Figure description, and the drawings.

FIG. 1 shows a perspective view of a round filter element for filtration of a gaseous fluid.

FIG. 2 shows a side view of the round filter element, partially in section.

FIG. 3 shows a section according to section line A-A of FIG. 2.

FIG. 4 shows a view from below of the round filter element.

FIG. 5 shows a perspective view of a round filter element in a housing.

FIG. 6 shows a detail view of the sealing action between round filter element and housing.

FIG. 7 shows a perspective view of a round filter element in a further embodiment.

FIG. 8 shows a section illustration of the embodiment according to FIG. 7.

FIG. 9 shows a detail view of the sealing action in the embodiment according to FIGS. 7 and 8.

In the Figures, same components are provided with same reference characters.

### DETAILED DESCRIPTION

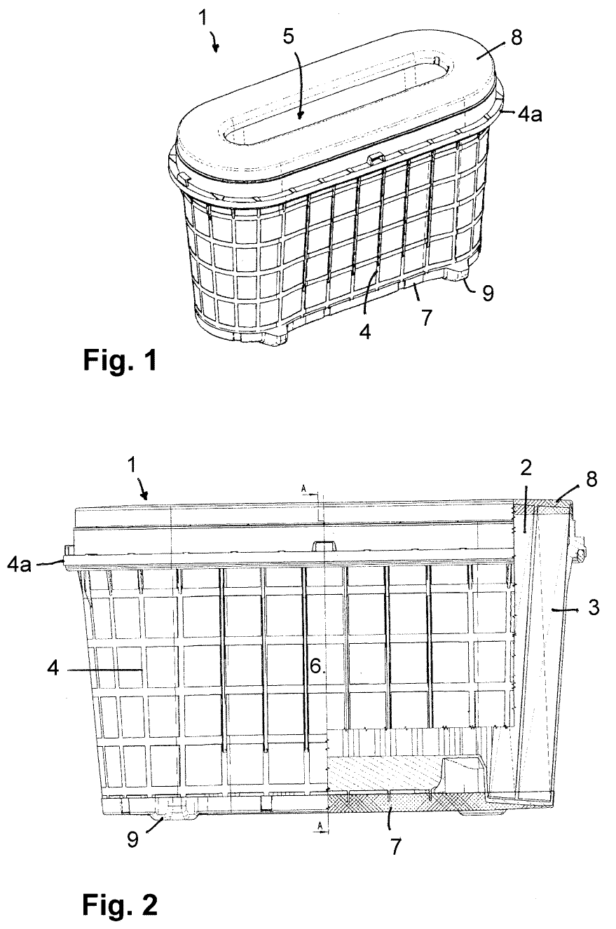

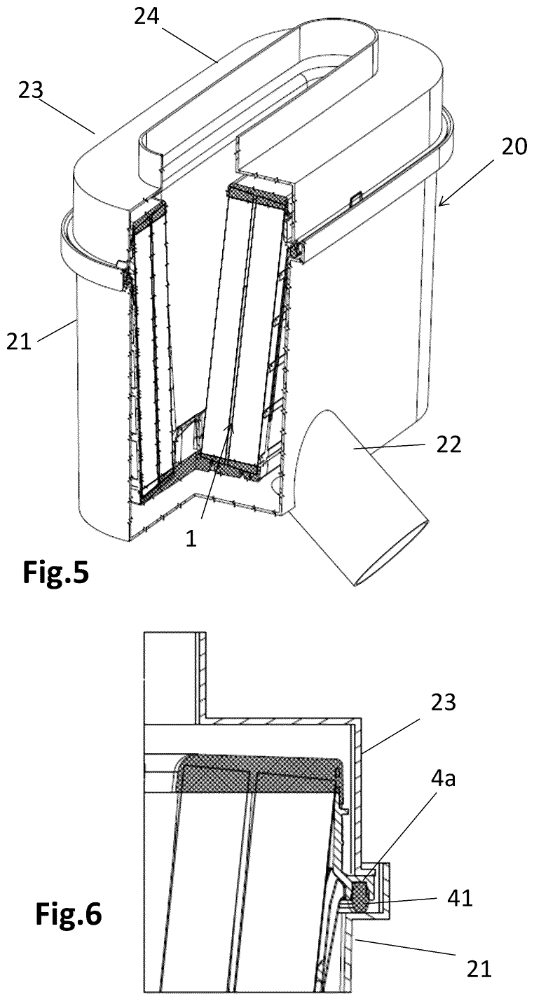

In FIGS. 1 to 4, a round filter element 1 for filtration of a gaseous fluid such as, for example, air, is illustrated. The round filter element 1 can be a component of a filter device illustrated in FIG. 5 with a filter housing into which the round filter element 1 is inserted. The filter device is used, for example, for filtration of the fresh air that is supplied to a fuel cell.

The round filter element 1 comprises two filter medium bodies 2, 3 configured as hollow bodies which are arranged concentrically relative to each other. The first inwardly positioned filter medium body 2 functions as a particle filter medium body and the second outwardly positioned filter medium body 3 as a noxious gas filter medium body. The filter medium bodies 2, 3 are configured similar to a hollow cylinder but they have no round but an elongate cross section shape with semicircular narrow sides and straight or equally concavely embodied longitudinal sides. Both filter medium bodies 2, 3 surround an inwardly positioned flow chamber 5 which receives the non-purified raw fluid. From the flow chamber 5, the non-purified raw fluid flows in radial direction first through the inwardly positioned particle filter medium body 2 and immediately afterwards through the surrounding outwardly positioned noxious gas filter medium body 3. The inwardly positioned wall side of the particle filter medium body 2 forms the raw or inflow side, the outwardly positioned wall side of the noxious gas filter medium body 3 the clean or outflow side.

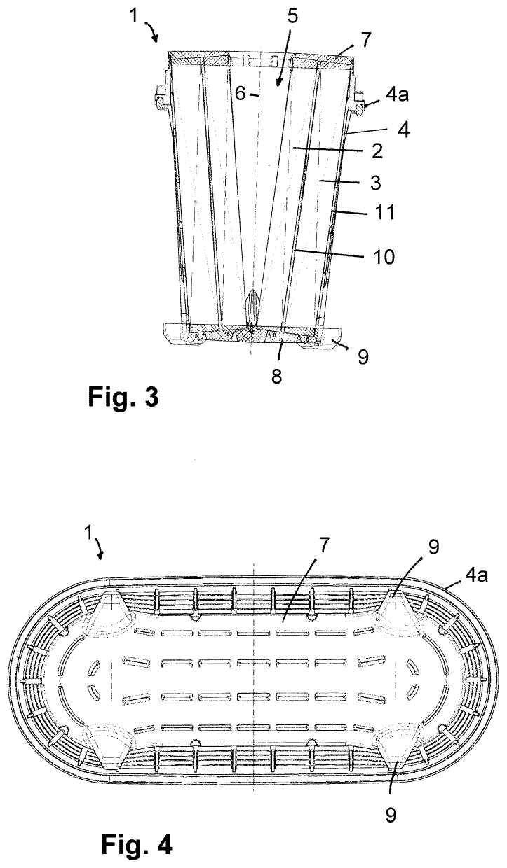

The round filter element 1 comprises in axial direction—in relation to the longitudinal axis 6 (FIGS. 2, 3)—a changing cross-sectional surface area. The cross-sectional surface area grows continuously from the bottom to the top in the shown illustration according to FIGS. 1 to 3; correspondingly, the smallest cross-sectional surface area is located at the lower end face and the largest cross-sectional surface area at the upper end face.

The two filter medium bodies 2, 3 are each embodied as bellows filters with a plurality of filter folds which extend in circumferential direction of each filter medium body 2, 3.

The two filter medium bodies 2, 3 are flowed through radially from the interior to the exterior. The inwardly positioned particle filter medium body 2 serves for separating particles in the supplied fluid. The outwardly positioned noxious gas filter medium body 3 arranged downstream of the particle filter medium body 2 serves for separating noxious gases such as, for example, sulfur dioxide, nitrogen oxide or ammonia, and can contain active carbon as a filtering agent.

At the outer side of the round filter element which is formed by the outwardly positioned wall side of the noxious gas filter medium body 3, a gas-permeable support element in the form of a support grid 4 is provided which extends across the entire outwardly positioned wall side in circumferential direction and in axial direction. The support grid 4 comprises stays, extending in axial direction and in circumferential direction, and intermediately positioned cutouts through which the purified fluid can exit. The support grid 4 is comprised advantageously of plastic material and serves for radial support of the outwardly positioned noxious gas filter medium body 3 and indirectly also of the inwardly positioned particle filter medium body 2.

A radially expanded collar 4a is formed as one piece together with the support grid 4 and serves for lateral support and sealing in the receiving filter housing. The radially expanded collar 4a is located adjacent to the upper end face of the round filter element 1.

The axially oppositely positioned end faces of the filter medium bodies 2 and 3 are flow-tightly covered by a respective end plate 7 and 8. The lower end plate 7 is continuous and without cutout while the upper end plate 8 comprises a central elongate cutout through which the raw fluid can flow axially into the inwardly positioned flow chamber.

The lower end plate 7 and the upper end plate 8 can be formed as a cast component. Each end plate 7, 8 covers flow-tightly the end face of the particle filter medium body 2 as well as of the noxious gas filter medium body 3. One obtains thus a flow-tight cover at each end face with only one end plate 7, 8, respectively. At the same time, this has the advantage that the relative position of the two filter medium bodies 2, 3 is fixed relative to each other. A section of the support grid 4 is also received in the end plates 7, 8 so that also the support grid 4 is held by the end plates 7, 8 and is fixed in its relative position to the outwardly positioned noxious gas filter medium body 3.

Laterally projecting support legs 9 are integrally formed at the lower closed end plate 7 and are formed as one piece together with the lower end plate 7. The support legs 9, which are located in transition between each longitudinal side to the semicircular narrow sides, permit for example, a lateral support action in the receiving filter housing, as needed, also an axial support action. As a whole, four such support legs 9 are formed at the lower end plate 7.

A narrow gap is located between the inwardly positioned particle filter medium body 2 and the outwardly positioned surrounding noxious gas filter medium body 3. A gas-permeable media layer in the form of an inner nonwoven layer 10 lies in this gap and acts so as to reduce friction and enables possibly occurring small relative movements between the filter medium bodies 2 and 3 without damaging the filter material due to its friction-reducing properties. The nonwoven layer 10 prevents that the filter folds of the filter medium bodies 2 and 3 get hooked at each other. The nonwoven layer 10 prevents also that particles which pass the inwardly positioned particle filter medium body 2 can reach accidentally the noxious gas filter medium body 3.

A further gas-permeable media layer in the form of an outer nonwoven layer 11 is located at the outwardly positioned wall side of the noxious gas filter medium body 3. The nonwoven layer 11 adjoins immediately the support grid 4 and is located thus between the noxious gas filter medium body 3 and the support grid 4. The nonwoven layer 11 also acts to reduce friction and prevents in this manner an undesirable friction contact between the noxious gas filter medium layer 3 and the support grid 4. In addition, the nonwoven layer 11, arranged downstream of the noxious gas filter medium body 3, prevents particles of the material of the noxious gas filter medium body 3, for example, active carbon particles, from being flushed out and reaching the clean side. The nonwoven layer 11 extends across almost the entire height of the noxious gas filter medium body 3 and ends shortly before the end faces of the noxious gas filter medium body 3 so that foaming around with the material of the end plates 7, 8 is ensured. Advantageously, the outer nonwoven layer 11 comprises a higher degree of separation for particles to be filtered than the nonwoven layer 10 arranged between the filter medium bodies 2, 3.

In an embodiment that is not illustrated, no support grid 4 or other rigid support element is provided. The disclosures that do not concern the support grid in connection with FIGS. 1 to 4 apply in analogy to such an embodiment.

In FIG. 5, an openable filter housing 20 with the round filter element 1 received therein is illustrated. The filter housing 20 comprises a first housing part 21 and a second housing part 23. At the first housing part 21, a socket 22 is arranged which in the illustrated example forms the outlet for the clean fluid. The second housing part 23 comprises a central opening 24 with a circumferentially extending collar through which the raw fluid to be purified can be introduced into the filter housing 20. The gas to be purified passes through the opening 24 into the filter housing 20, flows through the two filter medium bodies 2, 3 of the filter element 1 radially from the interior to the exterior and exits the filter housing 20 as purified gas through the socket 22. A reverse flow through the filter housing 20 is also conceivable, wherein the filter element 1 is then configured correspondingly for flow from the exterior to the interior.

In FIG. 6, a detail of a filter housing 20 with installed round filter element 1 is illustrated. The support grid 4 of the round filter element 1 comprises an expanded collar 4a which forms an axially downwardly oriented groove. A seal element 41, for example, an O-ring, is inserted in this groove. The seal could also be designed differently, for example, could be foamed or injection molded onto the expanded collar 4a. The first housing part 21 comprises a circumferentially extending contact surface for the seal element 41. When closing the filter housing 20, the seal element 41 is pressed axially against this contact surface and seals in this manner the clean side relative to the raw side.

In an embodiment, not illustrated, without outwardly positioned support grid 4, a circumferentially extending carrier frame for the seal element 41 can be provided. It is for example, embedded together with the filter medium bodies 2, 3 in the material of the upper end plate 8 and fixed in this way. The two filter medium bodies, the two end plates, the carrier frame, and the gas-permeable media layers, if present, form an inseparable structural unit.

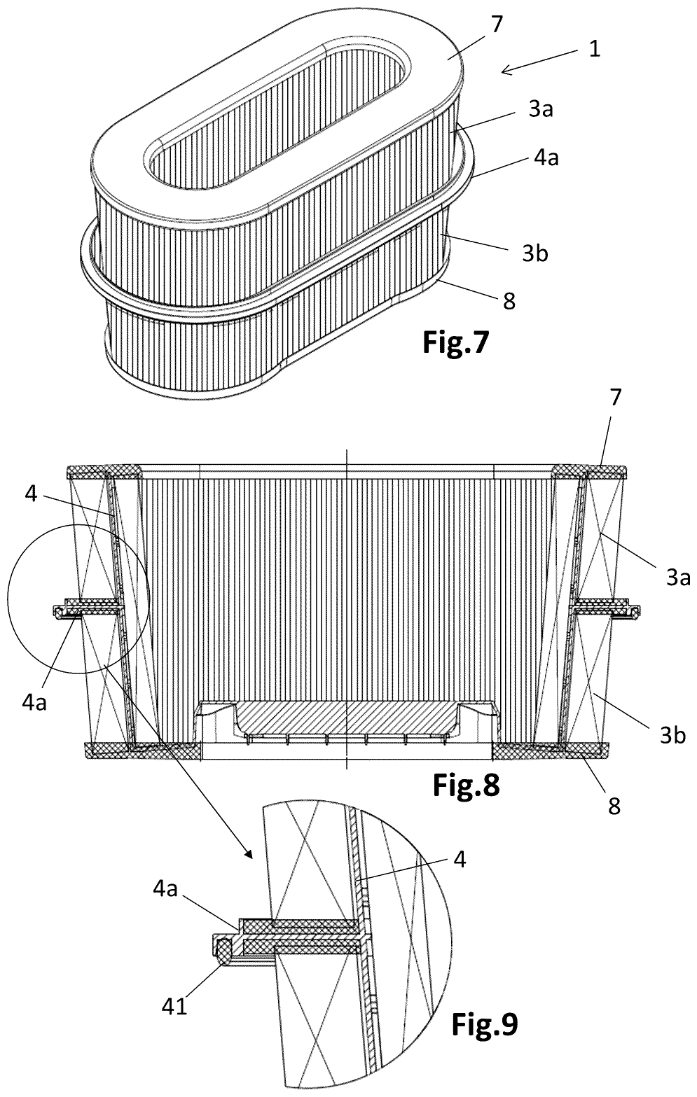

In FIGS. 7 to 9, an advantageous further embodiment of a round filter element with a two-part noxious gas filter medium body 3 is illustrated. The radially inwardly positioned particle filter medium body 2 is of a one-piece construction. The noxious gas filter medium body 3 is comprised here of two partial bodies 3a, 3b. In axial direction, they have the same length but could also have different lengths. Both partial bodies 3a, 3b are embodied as folded bellows. While the end faces of the two bellows 3a, 3b facing away from each other are embedded in the end plates 7, 8, the two end faces facing each other are sealed by adhesive. At the radially inwardly positioned side wall of the two partial bodies 3a, 3b, thus between the noxious gas filter medium body 3 and the particle filter medium body 2, a support grid 4 is arranged which comprises an expanded collar 4a which projects between the two partial bodies 3a, 3b radially outwardly and projects past the partial bodies 3a, 3b. The expanded collar 4a comprises a circumferential groove in which an annular seal element 41 is introduced. The end faces of the partial bodies 3a, 3b are for example, glued to the expanded collar 4a, wherein then no additional adhesive for sealing the open end faces is required.

In an alternative embodiment, not illustrated, the partial bodies 3a, 3b are directly glued to each other. The sealing action to the housing can then be realized, for example, as in the embodiment illustrated in FIG. 1, by a seal arrangement arranged at a radially outwardly positioned support grid or a separate seal carrier can be arranged in the region of the upper end plate 8, for example, embedded therein.

What is claimed is:

1. A round filter element for filtration of a gaseous fluid, the round filter element comprising:
a particle filter medium body configured as a hollow body for particle filtration of the gaseous fluid;
a noxious gas filter medium body configured as a hollow body for noxious gas filtration, wherein the noxious gas filter medium body is separate from the particle filter medium body and is arranged concentrically in relation to the particle filter medium body;
wherein the particle filter medium body and the noxious gas filter medium body surround an inwardly positioned flow chamber;
a first common end plate flow-tightly covering a first end face of the particle filter medium body and a first end face of the noxious gas filter medium body;
a second common end plate flow-tightly covering a second end face of the particle filter medium body and a second end face of the noxious gas filter medium body;
wherein the particle filter medium body is a filter bellows and wherein the noxious gas filter medium body is a filter bellows.

2. The round filter element according to claim 1, further comprising at least one gas-permeable media layer arranged at a wall side of the particle filter medium body or arranged at a wall side of the noxious gas filter medium body.

3. The round filter element according to claim 2, wherein the at least one gas-permeable media layer is arranged between the particle filter medium body and the noxious gas filter medium body.

4. The round filter element according to claim 2, wherein the at least one gas-permeable media layer is arranged at an outflow side of the noxious gas filter medium body.

5. The round filter element according to claim 2, wherein the at least one gas-permeable media layer extends across at least half a height of the noxious gas filter medium body.

6. The round filter element according to claim 5, wherein the at least one gas-permeable media layer extends across at least two thirds of the height of the noxious gas filter medium body.

7. The round filter element according to claim 2, wherein the at least one gas-permeable media layer includes a first media layer arranged between the particle filter medium body and the noxious gas filter medium body and further includes a second media layer arranged at an outflow side of the noxious gas filter medium body.

8. The round filter element according to claim 7, wherein the first media layer comprises a first degree of separation and the second media layer comprises a second degree of separation, wherein the first degree of separation is lower than the second degree of separation.

9. The round filter element according to claim 1, further comprising a gas-permeable support element arranged at a wall side of the particle filter medium body or arranged at a wall side of the noxious gas filter medium body.

10. The round filter element according to claim 9, wherein the particle filter medium body is arranged downstream of the noxious gas filter medium body in a flow direction of the gaseous fluid, wherein the gas-permeable support element is arranged at the wall side of the particle filter medium body, and wherein the wall side of the particle filter medium body is an outflow side.

11. The round filter element according to claim 9, wherein the noxious gas filter medium body is arranged downstream of the particle filter medium body in a flow direction of the gaseous fluid, wherein the gas-permeable support element is arranged at the wall side of the noxious gas filter medium body, and wherein the wall side of the noxious gas filter medium body is an outflow side.

12. The round filter element according to claim 9, wherein the gas-permeable support element projects into a material of at least one of the first and second common end plates and is fixedly connected to the at least one of the first and second common end plates.

13. The round filter element according to claim 9, further comprising at least one gas-permeable media layer arranged at the wall side of the particle filter medium body or arranged at the wall side of the noxious gas filter medium body, wherein the at least one gas-permeable media layer is fixedly connected to the gas-permeable support element.

14. The round filter element according to claim 9, further comprising a seal carrier, wherein the gas-permeable support element is connected to the seal carrier.

15. The round filter element according to claim 14, wherein the gas-permeable support element and the seal carrier are configured together as one piece.

16. The round filter element according to claim 1, wherein the particle filter medium body is inwardly arranged and immediately adjoins the inwardly positioned flow chamber, and wherein the noxious gas filter medium body is positioned outwardly and surrounds the inwardly positioned particle filter medium body.

17. The round filter element according to claim 1, wherein at least one of the particle filter medium body and the noxious gas filter medium body is a multi-part filter medium body comprising at least two partial bodies connected to each other at axial end faces thereof.

18. The round filter element according to claim 17, further comprising a seal carrier, wherein the multi-part filter medium body is outwardly positioned, wherein the seal carrier is provided between the at least two partial bodies and projects radially outwardly past the at least two partial bodies, wherein the seal carrier carries a seal element.

19. A filter device comprising:
a round filter element according to claim 1; and
an openable filter housing configured to receive the round filter element.

20. The filter device according to claim 19, configured for use in a fuel cell.
